(19) United States
(12) Patent Application Publication
(10) Pub. No.: US 2024/0024923 A1
(43) Pub. Date: Jan. 25, 2024

(54) SPRAY GUN CLEANING DEVICE

(71) Applicant: Lavigne Product Enterprises LLC, Bowdoin Center, ME (US)

(72) Inventor: Eric Lavigne, Bowdoin Center, ME (US)

(73) Assignee: Lavigne Product Enterprises LLC, Bowdoin Center, ME (US)

(21) Appl. No.: 17/872,694

(22) Filed: Jul. 25, 2022

(51) Int. Cl. B08B 1/00; B05B 15/52; B08B 9/023

(52) U.S. Cl. CPC B08B 1/005; B05B 15/52; B08B 9/023; B08B 2209/02

(57) ABSTRACT

The present invention relates to a cleaning device for a spray gun. More specifically, the present invention relates to a device with features to clean the barrel and nozzle of an insulation spray gun. Still more specifically, the present invention is a device used to scrape excess spray foam insulation from a spray gun barrel and provide features to scrape, peel, or otherwise remove excess spray foam insulation from the nozzle of the spray gun to improve performance and longevity of the spray gun.

### BACKGROUND OF THE INVENTION

### 1. Field of the Invention

The present invention relates to a device for removing residue, excess material, and other unwanted deposits from an apparatus. More specifically, the present invention relates to cleaning and removing material from a spray gun. Even more specifically, the present invention relates to a device for cleaning hardened product off a spray gun applicator for spray foam insulation.

### 2. Description of the Prior Art

Spray form insulation has grown in popularity over the last few years with new home construction and renovations. It provides an alternative to other types of insulation, such fiberglass batts, which generally requires more manpower and time for installation. Spray foam insulation allows a single individual to apply the mixture to the desired area in a significantly less amount of time than previously required. Additionally, the foam insulation mixture expands into the surrounding space, providing more efficient performance. The application of spray foam insulation is done with a spray gun. The spray gun has a tube connected to the device which supplies the gun with the insulation mixture. The barrel of the gun is an extended length such that the individual can access harder to reach areas and apply the insulation mixture where needed. When the insulation mixture is applied, it starts out in a liquid form and expands into a foam when applied, which eventually solidifies shortly after application. During the application process, some of the spray foam mixture may remain on the spray gun barrel, handle, and other areas of the spray gun, affecting the performance of the spray gun.

The spray gun will typically become exposed to the insulation material, which then expands and hardens in and on the gun barrel. This can affect performance, requiring the user to periodically stop work to clean and scrape the insulation material off the spray gun, or even be forced to replace the spray gun. Currently, individuals will use a knife, razor blade, or other sharp surface to scrape off the hardened material from the spray gun. This can be time consuming and inefficient as the blades are not suited to quickly and easily clean the residue from the gun. In particular, using a razor blade or knife is slow, inefficient, dulls the knife which is typically needed for other uses, and does not provide effective cleaning of the barrel and nozzle to sufficiently improve the performance of the spray gun.

What is needed is a device which provides quick and easy cleaning of a spray gun barrel and nozzle. What is further needed is a device which is specifically designed to be used with an insulation spray gun to remove excess insulative material which collects on the barrel and the nozzle of the spray gun. What is needed is a device specifically designed for use with the spray gun such that the device can clear the hardened and expanded insulative material from key areas of the spray gun, thereby improving the performance of the spray gun and increase the useable lifespan of the spray gun.

### SUMMARY OF THE INVENTION

The present invention is a spray gun cleaning device. The device is designed to allow for quick and easy cleaning of a foam insulation application spray gun. More specifically, the device is suited to remove spray foam insulation from a spray gun to improve performance and increase the lifespan of the spray gun. The device has features that allow for the removal of hardened insulation material from the barrel and nozzle of the spray gun.

The cleaning device has a feature to accommodate the long, rounded barrel of the spray gun to quickly and efficiently remove excess insulation material from the barrel. Additionally, the device has additional features which engage with the nozzle of the spray gun to remove the buildup of hardened material in and around the nozzle.

The cleaning device has a sharp edge with an arc similar to that of the spray gun barrel arc. The arced edge allows the user to scrape the barrel of the spray gun, removing the built-up insulation material. The cleaning device also has a nozzle hole which fits the nozzle of the spray gun. The nozzle hole provides friction around the nozzle to clear the nozzle of insulation material. The nozzle hole may be grooved, textured, or may be equipped to hold a razor blade. The nozzle hole is specifically designed to scrape and remove built-up insulation material from the nozzle of the spray gun.

The cleaning device may also be configured such that the cleaning device can fit inside a spray gun for easy and convenient storage. In an embodiment, the device has a base on which the barrel scraper is located. The nozzle hole or plurality of nozzle holes are located on a body. In this embodiment, the body of the device may be inserted into the open space of the handle of the spray gun and the base of the device rests on the edge of the hollow handle of the spray gun. The user may grasp the base of the device to easily pull the device out from the hollow handle of the spray gun to use as excess insulation material collects on the spray gun.

### BRIEF DESCRIPTION OF THE DRAWINGS

FIG. 1 is a top perspective view of the cleaning device.

FIG. 2 is a side perspective view of the cleaning device.

FIG. 3 is a bottom perspective view of the cleaning device.

FIG. 4 is a front perspective view of the cleaning device.

FIG. 5 is a perspective view of the cleaning device in association with the spray gun barrel.

FIG. 6 is a perspective view of the cleaning device in association with the spray gun nozzle.

FIG. 7 is a perspective view of the cleaning device in association with the spray gun nozzle.

### DETAILED DESCRIPTION OF THE INVENTION

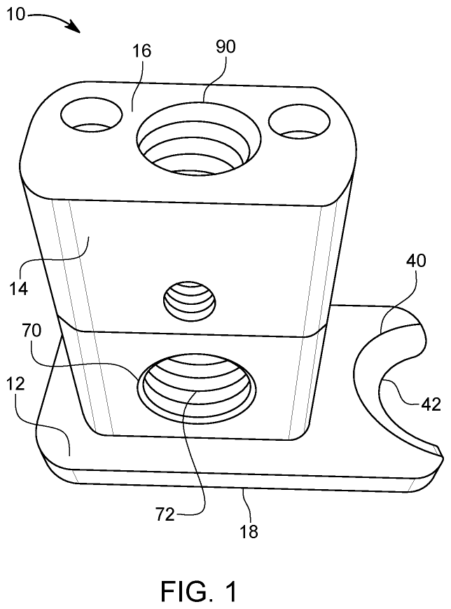

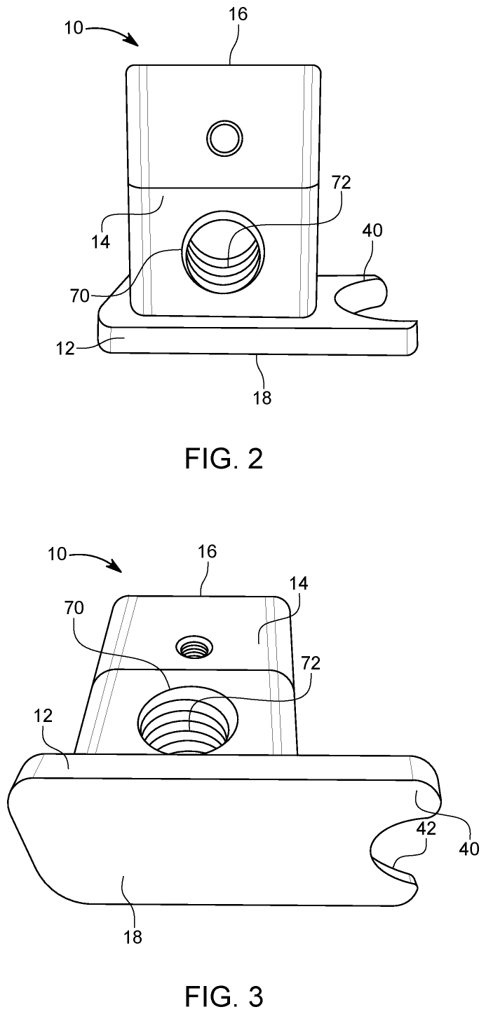

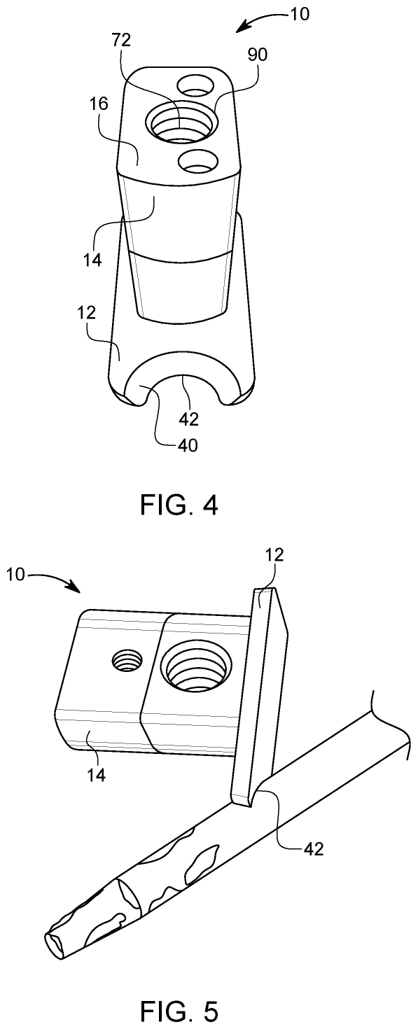

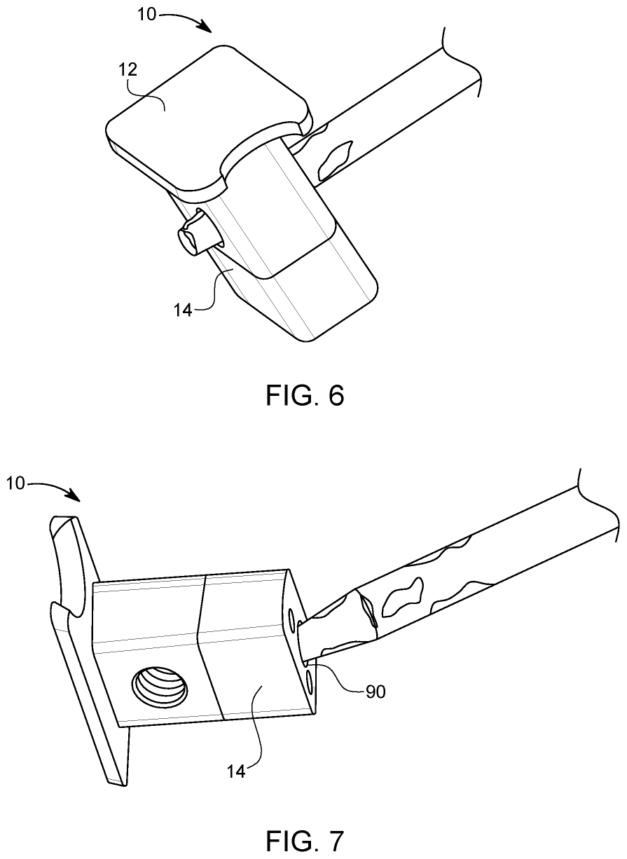

An embodiment of a spray gun cleaning device 10 of the present invention is shown in FIGS. 1-4. An embodiment of the spray gun cleaning device 10 of the present invention is shown in use with a spray gun in FIGS. 5-6. The device 10 has a base 12, a body 14, a first end 16 and a second end 18. The base 12 has a scraper 40. The scraper 40 has an edge 42. The body 14 has a nozzle hole 70 and an optional secondary nozzle hole 90. The nozzle hole 70 has a plurality of grooves 72.

The edge 42 of the scraper 40 of the current embodiment is an arcuate shape. The arcuate shape is designed to function with a rounded surface. The edge 42 of the scraper 40 may not be limited to an arcuate shape. The edge 42 is sufficiently sharp to travel between the desired surface and excess, collected material, thereby separating the excess, collected material from the desired surface. In the current embodiment, the edge 42 is of an arcuate shape having an inner radius of curvature selected to match substantially an outer radius of curvature of a barrel of an insulation spray gun. As depicted in FIG. 5, the arcuate shape provides greater surface area contact with the barrel of the spray gun of a rounded design. In the event the barrel of the spray gun is other than round, the edge 42 of the scraper 40 may be configured with a contact surface designed to match substantially that of the spray gun barrel. Spray foam insulation may collect, expand, and harden in various areas, namely the barrel of the insulation spray gun. The edge 42 is sufficiently sharp enough to separate the hardened spray foam material from the barrel of the spray gun when scraped along it to clean the barrel and improve performance of the spray gun.

The nozzle hole 70 of the body 14 of the device 10 is designed to fit the tip or nozzle of a spray gun apparatus as depicted in FIG. 6. The nozzle hole 70 may have a plurality of grooves 72 to generate additional friction. The nozzle hole 70 of the present embodiment is designed to fit the tip or nozzle portion of an insulation spray gun. Spray foam insulation may collect, expand, and harden in various areas, including the nozzle of the insulation spray gun. This collection of excess spray foam insulation can impact the performance of the spray gun, and even render it unusable, requiring the purchase of a new spray gun. The nozzle hole 70 of the present device 10 is designed to fit the tip and nozzle of an insulation spray gun. The user may then insert, remove, twist, pivot, or otherwise move the device 10 or the spray gun to remove the hardened insulation material from the spray gun nozzle. The plurality of grooves 72 provides additional friction and scraping ability to further clean the nozzle of the spray gun.

As depicted in FIG. 7, the secondary nozzle hole 90 provides an additional source of scraping for the nozzle of the spray gun. The secondary nozzle hole 90 may be of similar, smaller, or larger size to that of the nozzle hole 70. The secondary nozzle hole 90 may also have a plurality of grooves 92. The secondary nozzle hole 90 may provide a similar function to the nozzle hole 70 but be equipped with different features or diameter to provide another source of scraping and clearing the spray gun nozzle of excess materials.

The nozzle hole 70 and the secondary nozzle hole 90 may also have a removable or replaceable razor blade receiving feature. A razor blade may be inserted into the device 10 wherein the sharp edge of the razor blade sits partially within the nozzle hole 70 or the secondary nozzle hole 90 to provide additional scraping and cleaning ability.

The present embodiment of the device 10 is designed such that the device 10 may fit securely in the handle of a spray gun for easy access and use as needed. The body 14 of the device 10 is of a form and shape such that the body 14 will fit securely within the hollow handle of a spray gun. The base 12 of the device 10 may rest flush with the bottom of the handle of a spray gun to prevent the device 10 from slipping too far into the hollow handle of the spray gun. Additionally, the user may grasp the base 12 of the device 10 to remove the device 10 from the handle of the spray gun for use.

The present invention has been described with reference to specific examples and configurations. The description is not to be taken in a limiting sense but is made merely for the purpose of illustrating the general principles of the invention, since the scope of the invention is best defined by the appended claims.

What is claimed is:

1. A cleaning device configured to remove excess materials from a spray gun applicator, the device comprising:
a body;
a base;
a scraper; and
wherein the scraper has an edge arranged to remove excess material from the periphery of the spray gun applicator.

2. The device of claim 1 wherein the device has a nozzle hole, and wherein the nozzle hole has a feature arranged to remove excess material from a nozzle.

3. The device of claim 1 wherein the nozzle hole is located on the body.

4. The device of claim 1 wherein the scraper is located on the base.

5. The device of claim 1 wherein device is arranged in a shape to fit securely within a hollow handle of a spray gun applicator.

6. The device of claim 1 wherein the device is configured to receive and retain a razor blade.

7. The device of claim 1 wherein the scraper is an arcuate shape.
